(19) United States
(12) Patent Application Publication
(10) Pub. No.: US 2025/0060656 A1
(43) Pub. Date: Feb. 20, 2025

(54) ILLUMINATION SYSTEM AND PROJECTION DEVICE

(71) Applicant: Qisda Corporation, Taoyuan City (TW)

(72) Inventors: Ching-Tze Huang, Taoyuan City (TW); Yu Cheng Chen, Taoyuan City (TW)

(73) Assignee: Qisda Corporation, Taoyuan City (TW)

(21) Appl. No.: 18/774,886

(22) Filed: Jul. 16, 2024

(30) Foreign Application Priority Data
Aug. 17, 2023 (CN) 202311035909.6

(51) Int. Cl. G03B 21/20; G03B 21/28

(52) U.S. Cl. CPC G03B 21/204; G03B 21/208; G03B 21/28

(57) ABSTRACT

An illumination system, configured to generate an illumination light beam, is provided. The illumination system includes an excitation light source configured to emit an excitation light beam and a light guide module, a collimation lens group, and a wavelength conversion element disposed on a transmission path of the excitation light beam. After being emitted from the excitation light source, the excitation light beam is reflected by the light guide module, passes through the collimation lens group, and is transmitted to the wavelength conversion element. A part of the excitation light beam is reflected by the wavelength conversion element, and passes through the collimation lens group and the light guide module. Another part of the excitation light beam is converted into a conversion light beam by the wavelength conversion element. The conversion light beam passes through the collimation lens group and the light guide module. A projection device is also provided.

### CROSS-REFERENCE TO RELATED APPLICATION

This application claims the priority benefit of China application serial no. 202311035909.6, filed on Aug. 17, 2023. The entirety of the above-mentioned patent application is hereby incorporated by reference herein and made a part of this specification.

### BACKGROUND

### Technical Field

The disclosure relates to an optical system and an optical device, and in particular to an illumination system and a projection device.

### Description of Related Art

Generally speaking, an illumination system used in a projection device is composed of elements such as a light source module, a focusing collimation module, a light uniform element, and a light guide module. After an illumination light beam generated by the illumination system is converted into an image light beam by a light valve, the image light beam is projected out of the projection device through a projection lens.

When a usage environment, such as an automotive illumination light, requires a device to be reduced in size, in addition to the need to reduce the size, the illumination system also needs to comply with regulatory requirements such as color temperature and brightness.

### SUMMARY

The disclosure provides an illumination system and a projection device, which are relatively small in size and can improve light energy usage efficiency.

An embodiment of the disclosure provides an illumination system, which is configured to generate an illumination light beam. The illumination system includes an excitation light source, a light guide module, a collimation lens group, and a wavelength conversion element. The excitation light source is configured to emit an excitation light beam. The light guide module, the collimation lens group, and the wavelength conversion element are disposed on a transmission path of the excitation light beam. After being emitted from the excitation light source, the excitation light beam is reflected by the light guide module, passes through the collimation lens group, and is then transmitted to the wavelength conversion element in sequence. A part of the excitation light beam is reflected by the wavelength conversion element, passes through the collimation lens group, and then passes through the light guide module in sequence, and another part of the excitation light beam is converted into a conversion light beam by the wavelength conversion element. The conversion light beam passes through the collimation lens group and then passes through the light guide module. The part of the excitation light beam and the conversion light beam emitted from the light guide module form the illumination light beam.

An embodiment of the disclosure provides a projection device, which is configured to generate an image light beam. The projection device includes an illumination system, a light valve, and a projection lens. The illumination system is configured to provide an illumination light beam and includes an excitation light source, a light guide module, a collimation lens group, and a wavelength conversion element. The excitation light source is configured to emit an excitation light beam. The light guide module, the collimation lens group, and the wavelength conversion element are disposed on a transmission path of the excitation light beam. After being emitted from the excitation light source, the excitation light beam is reflected by the light guide module, passes through the collimation lens group, and is then transmitted to the wavelength conversion element in sequence. A part of the excitation light beam is reflected by the wavelength conversion element, passes through the collimation lens group, and then passes through the light guide module in sequence, and another part of the excitation light beam is converted into a conversion light beam by the wavelength conversion element. The conversion light beam passes through the collimation lens group and then passes through the light guide module. The part of the excitation light beam and the conversion light beam emitted from the light guide module form the illumination light beam. The light valve is disposed on a transmission path of the illumination light beam to convert the illumination light beam into the image light beam. The projection lens is disposed on a transmission path of the image light beam to project the image light beam out of the projection device.

Based on the above, in an embodiment of the disclosure, the illumination system is composed of the excitation light source, the light guide module, the collimation lens group, and the wavelength conversion element, and the excitation light beam emitted by the excitation light source is guided toward the wavelength conversion element by (total) reflection. Therefore, in the illumination system, the number of optical elements in the light path is reduced and the design of the light path is simplified, which can reduce light energy loss, thereby improving light energy usage efficiency. At the same time, the system cost can be lowered and the system size can be reduced. Furthermore, the illumination light beam includes a combination of different color light beams such as the part of the excitation light beam and the conversion light beam, which is beneficial to improving the color performance and the uniformity performance of the system.

### BRIEF DESCRIPTION OF THE DRAWINGS

FIG. 1 is a schematic diagram of an illumination system according to a first embodiment of the disclosure.

FIG. 2 is a schematic diagram of a wavelength conversion element in FIG. 1.

FIG. 3 is a schematic diagram of an illumination system according to a second embodiment of the disclosure.

FIG. 4 is a schematic diagram of a projection device according to the first embodiment of the disclosure.

FIG. 5 is a schematic diagram of a projection device according to the second embodiment of the disclosure.

### DESCRIPTION OF THE EMBODIMENTS

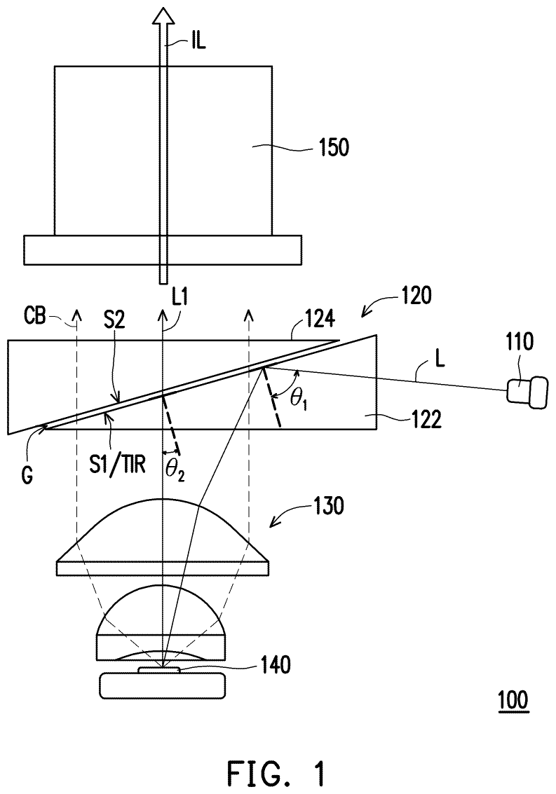

FIG. 1 is a schematic diagram of an illumination system according to a first embodiment of the disclosure. Please refer to FIG. 1. An embodiment of the disclosure provides an illumination system 100 configured to generate an illumination light beam IL. The illumination system 100 includes an excitation light source 110, a light guide module 120, a collimation lens group 130, and a wavelength conversion element 140.

In the embodiment, the excitation light source 110 is configured to emit an excitation light beam L. The excitation light source 110 is, for example, a light-emitting diode (LED), a laser diode (LD), or other suitable light sources.

In the embodiment, the collimation lens group 130 is, for example, a combination including one or more optical lenses with refractive power. The disclosure does not limit the form and the type of the collimation lens group 130.

In the embodiment, the light guide module 120, the collimation lens group 130, and the wavelength conversion element 140 are disposed on a transmission path of the excitation light beam L. After being emitted from the excitation light source 110, the excitation light beam L is reflected by the light guide module 120 (after entering the light guide module 120), passes through the collimation lens group 130, and is then transmitted to the wavelength conversion element 140 in sequence. Then, a part of the excitation light beam L (for example, a light beam L1) is reflected by the wavelength conversion element 140, passes through the collimation lens group 130, and then passes through the light guide module 120 in sequence, and another part of the excitation light beam is converted into a conversion light beam CB by the wavelength conversion element 140. The conversion light beam CB passes through the collimation lens group 130 and then passes through the light guide module 120. The part of the excitation light beam L and the conversion light beam CB emitted from the light guide module 120 form the illumination light beam IL. The excitation light beam L is, for example, a blue light beam, and the conversion light beam CB is, for example, a yellow light beam, so the illumination light beam IL may be a white light beam, but the disclosure is not limited thereto.

In the embodiment, the light guide module 120 has a total internal reflection surface TIR, wherein the excitation light beam L emitted from the excitation light source 110 is incident on the total internal reflection surface TIR at a first angle θ1, and the part of the excitation light beam L or the conversion light beam CB is incident on the total internal reflection surface TIR at a second angle θ2. The first angle θ1 is greater than a critical angle of the total internal reflection surface TIR, and the second angle θ1 is less than the critical angle of the total internal reflection surface TIR.

In the embodiment, the light guide module 120 includes a first prism 122 and a second prism 124. The first prism 122 is disposed between the second prism 124 and the collimation lens group 130. An interface S1 of the first prism 122 adjacent to the second prism 124 is the total internal reflection surface TIR.

In the embodiment, there is a gap G between the first prism 122 and the second prism 124. The material of the illumination system 100 at the gap G and the material of the first prism 122 determine the critical angle. Furthermore, the refractive index of the material of the first prism 122 is greater than the refractive index of the material of the gap G. For example, the material of the first prism 122 may be glass, and the material of the gap G may be air or a glue layer with a refractive index less than the refractive index of the material of the first prism 122, but the disclosure is not limited thereto.

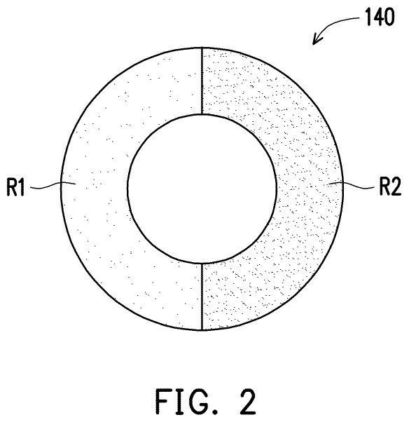

FIG. 2 is a schematic diagram of a wavelength conversion element in FIG. 1. Please refer to FIG. 2. In the embodiment, the wavelength conversion element 140 includes a wavelength conversion region R1 and a non-wavelength conversion region R2. The part of the excitation light beam L is incident on the non-wavelength conversion region R2, and the another part of the excitation light beam L is incident on the wavelength conversion region R1. The excitation light beam (the another part) is converted into the conversion light beam CB by the wavelength conversion region R1.

In the embodiment, the wavelength conversion element 140 is a fixed member or a rotatable member. When the wavelength conversion element 140 is selected as a rotatable member, the illumination system 100 respectively generates the part of the excitation light beam L (for example, the beam L1) and the conversion light beam CB at different timings. For example, at a first timing, the non-wavelength conversion region R2 cuts into the transmission path of the excitation light beam L, and the illumination system 100 generates the part of the excitation light beam L; and at a second timing, the wavelength conversion region R1 cuts into the transmission path of the excitation light beam L, and the illumination system 100 generates the conversion light beam CB.

Please refer to FIG. 1 again. In the embodiment, the illumination system 100 further includes a projection lens 150. The projection lens 150 is disposed on a transmission path of the illumination light beam IL and is configured to project the illumination light beam IL out of the illumination system 100. The projection lens 150 is, for example, a combination of one or more optical lenses with refractive power. The disclosure does not limit the form and the type of the projection lens 150.

Based on the above, in an embodiment of the disclosure, the illumination system 100 includes the excitation light source 110, the light guide module 120, the collimation lens group 130, and the wavelength conversion element 140. Moreover, the excitation light beam L emitted by the excitation light source 110 is guided toward the wavelength conversion element 140 by (total) reflection. Therefore, in the illumination system 100, the number of optical elements in the light path is reduced and the design of the light path is simplified, which can reduce light energy loss, thereby improving light energy usage efficiency. Moreover, under the conditions of reducing the optical elements and simplifying the light path, the system cost can be lowered and the system size can be reduced. Furthermore, the illumination light beam IL includes the part of the excitation light beam L and the conversion light beam CB, which is beneficial to improving the color performance and the uniformity performance of the system. Therefore, the illumination system 100 can meet specifications such as color temperature and brightness.

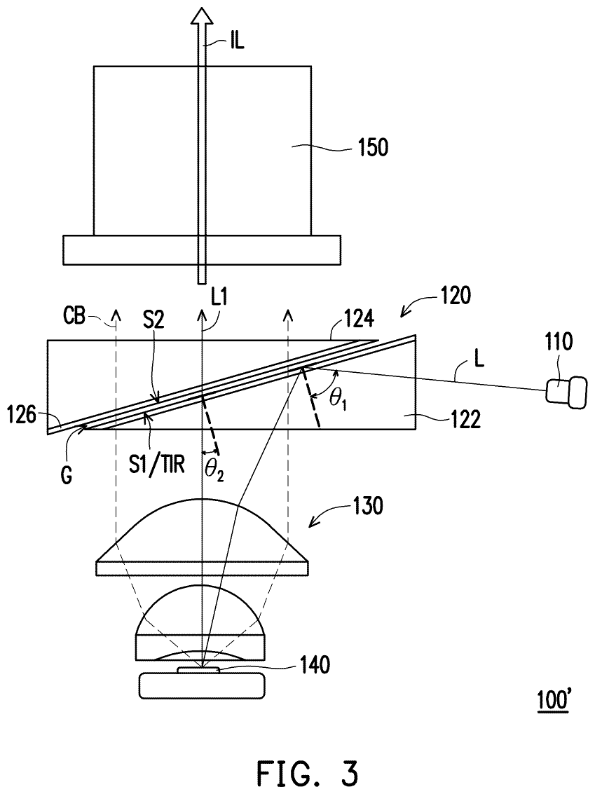

FIG. 3 is a schematic diagram of an illumination system according to a second embodiment of the disclosure. Please refer to FIG. 3. An illumination system 100′ is similar to the illumination system 100 of FIG. 1. The main difference is that the illumination system 100′ further includes multiple anti-reflection films 126. The anti-reflection films 126 are disposed at the interface S1 of the first prism 122 adjacent to the second prism 124 and at an interface S2 of the second prism 124 adjacent to the first prism 122. Since the illumination system 100′ of the embodiment of the disclosure is provided with the anti-reflection films 126 at the interfaces S1 and S2, light energy loss in the system can be reduced and light energy usage efficiency can be improved. The remaining advantages of the illumination system 100′ are similar to those of the illumination system 100 and are not reiterated here.

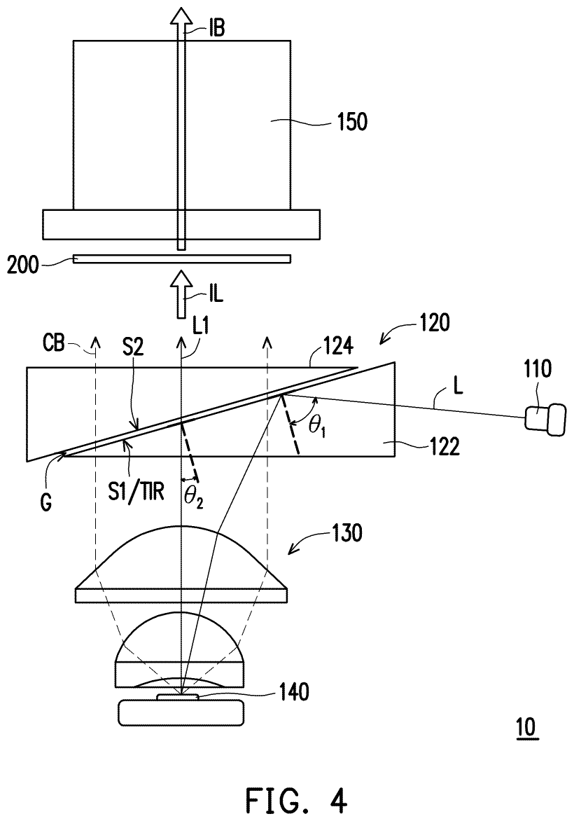

FIG. 4 is a schematic diagram of a projection device according to the first embodiment of the disclosure. Please refer to FIG. 4. An embodiment of the disclosure provides a projection device 10 configured to generate the image light beam IB. The projection device 10 includes the illumination system 100, a light valve 200, and the projection lens 150. The illumination system 100 of FIG. 4 is similar to the illumination system 100 of FIG. 1 or the illumination system 100′ of FIG. 3 and is not reiterated here.

In addition, in the embodiment, the light valve 200 is disposed on the transmission path of the illumination light beam IL and is configured to convert the illumination light beam IL into the image light beam IB. The projection lens 150 is disposed on a transmission path of the image light beam IB and is configured to project the image light beam IB out of the projection device 10. The light valve 200 is disposed between the projection lens 150 and the light guide module 120. The light valve 200 may be a transmissive liquid crystal panel. The advantages of the projection device 10 are similar to those of the illumination systems 100 and 100′ and are not reiterated here.

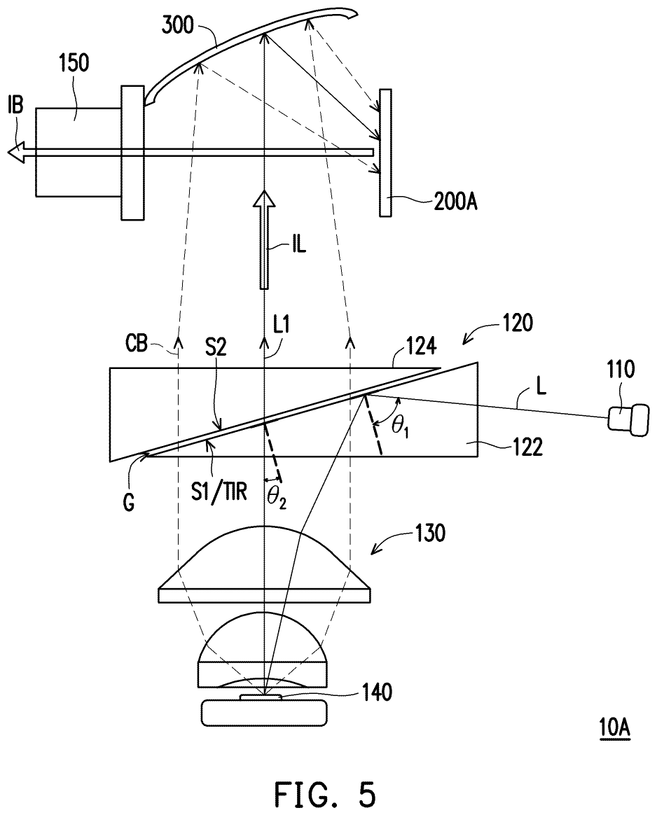

FIG. 5 is a schematic diagram of a projection device according to the second embodiment of the disclosure. Please refer to FIG. 5. A projection device 10A is similar to the projection device 10 of FIG. 4. The main difference is that the projection device 10A further includes a curved surface reflector 300. The curved surface reflector 300 is disposed on the transmission path of the illumination light beam IL and is configured to transmit the illumination light beam IL from the light guide module 120 to the light valve 200. A reflective surface of the curved surface reflector 300 may be an aspherical curved surface, a free-form curved surface, or a free-form curved surface with different refractive powers on different axes perpendicular to an optical axis thereof.

In the embodiment, a light valve 200A may be a digital micro-mirror device (DMD). The curved surface reflector 300 is disposed between the projection lens 150 and the light valve 200A. The advantages of the projection device 10A are similar to those of the projection device 10 and are not reiterated here.

In summary, in an embodiment of the disclosure, the illumination system is composed of the excitation light source, the light guide module, the collimation lens group, and the wavelength conversion element, and the excitation light beam emitted by the excitation light source is guided toward the wavelength conversion element by (total) reflection. Therefore, in the illumination system, the number of optical elements in the light path is reduced and the design of the light path is simplified, which can reduce light energy loss, thereby improving light energy usage efficiency. Moreover, under the conditions of reducing the optical elements and simplifying the light path, the system cost can be lowered and the system size can be reduced. Furthermore, the illumination light beam includes a combination of different color light beams such as the part of the excitation light beam and the conversion light beam, which is beneficial to improving the color performance and the uniformity performance of the system.

What is claimed is:

1. An illumination system, configured to produce an illumination light beam, comprising:
an excitation light source, configured to emit an excitation light beam;
a light guide module, disposed on a transmission path of the excitation light beam;
a collimation lens group, disposed on the transmission path of the excitation light beam; and
a wavelength conversion element, disposed on the transmission path of the excitation light beam,
wherein after being emitted from the excitation light source, the excitation light beam is reflected by the light guide module, passes through the collimation lens group, and is then transmitted to the wavelength conversion element in sequence, a part of the excitation light beam is reflected by the wavelength conversion element, passes through the collimation lens group, and then passes through the light guide module in sequence, another part of the excitation light beam is converted into a conversion light beam by the wavelength conversion element, and the conversion light beam passes through the collimation lens group and then passes through the light guide module,
wherein the part of the excitation light beam and the conversion light beam emitted from the light guide module form the illumination light beam.

2. The illumination system according to claim 1, wherein the light guide module has a total internal reflection surface, wherein the excitation light beam emitted from the excitation light source is incident on the total internal reflection surface at a first angle, the part of the excitation light beam or the conversion light beam is incident on the total internal reflection surface at a second angle, the first angle is greater than a critical angle of the total internal reflection surface, and the second angle is less than the critical angle of the total internal reflection surface.

3. The illumination system according to claim 2, wherein the light guide module comprises a first prism and a second prism, and the first prism is disposed between the second prism and the collimation lens group, wherein an interface of the first prism adjacent to the second prism is the total internal reflection surface.

4. The illumination system according to claim 3, wherein there is a gap between the first prism and the second prism, and a material of the illumination system at the gap and a material of the first prism determine the critical angle.

5. The illumination system according to claim 3, further comprising:
a plurality of anti-reflection films, disposed at the interface of the first prism adjacent to the second prism and an interface of the second prism adjacent to the first prism.

6. The illumination system according to claim 1, wherein the wavelength conversion element comprises a wavelength conversion region and a non-wavelength conversion region, the part of the excitation light beam is incident on the non-wavelength conversion region, the another part of the excitation light beam is incident on the wavelength conversion region, and the excitation light beam is converted into the conversion light beam by the wavelength conversion region.

7. The illumination system according to claim 1, wherein the wavelength conversion element is a fixed member or a rotatable member.

8. The illumination system according to claim 1, further comprising:
a projection lens, disposed on a transmission path of the illumination light beam and configured to project the illumination light beam out of the illumination system.

9. A projection device, configured to generate an image light beam, comprising:
an illumination system, configured to provide an illumination light beam, comprising:
an excitation light source, configured to emit an excitation light beam;
a light guide module, disposed on a transmission path of the excitation light beam;
a collimation lens group, disposed on the transmission path of the excitation light beam; and
a wavelength conversion element, disposed on the transmission path of the excitation light beam,
wherein after being emitted from the excitation light source, the excitation light beam is reflected by the light guide module, passes through the collimation lens group, and is then transmitted to the wavelength conversion element in sequence, a part of the excitation light beam is reflected by the wavelength conversion element, passes through the collimation lens group, and then passes through the light guide module in sequence, another part of the excitation light beam is converted into a conversion light beam by the wavelength conversion element, and the conversion light beam passes through the collimation lens group and then passes through the light guide module,
wherein the part of the excitation light beam and the conversion light beam emitted from the light guide module form the illumination light beam;
a light valve, disposed on a transmission path of the illumination light beam and configured to convert the illumination light beam into the image light beam; and
a projection lens, disposed on a transmission path of the image light beam and configured to project the image light beam out of the projection device.

10. The projection device according to claim 9, wherein the light guide module has a total internal reflection surface, wherein the excitation light beam emitted from the excitation light source is incident on the total internal reflection surface at a first angle, the part of the excitation light beam or the conversion light beam is incident on the total internal reflection surface at a second angle, the first angle is greater than a critical angle of the total internal reflection surface, and the second angle is less than the critical angle of the total internal reflection surface.

11. The projection device according to claim 10, wherein the light guide module comprises a first prism and a second prism, and the first prism is disposed between the second prism and the collimation lens group, wherein an interface of the first prism adjacent to the second prism is the total internal reflection surface.

12. The projection device according to claim 11, wherein there is a gap between the first prism and the second prism, and a material of the illumination system at the gap and a material of the first prism determine the critical angle.

13. The projection device according to claim 11, further comprising:
a plurality of anti-reflection films, disposed at the interface of the first prism adjacent to the second prism and an interface of the second prism adjacent to the first prism.

14. The projection device according to claim 9, wherein the wavelength conversion element comprises a wavelength conversion region and a non-wavelength conversion region, the part of the excitation light beam is incident on the non-wavelength conversion region, the another part of the excitation light beam is incident on the wavelength conversion region, and the excitation light beam is converted into the conversion light beam by the wavelength conversion region.

15. The projection device according to claim 9, wherein the wavelength conversion element is a fixed member or a rotatable member.

16. The projection device according to claim 9, wherein the light valve is a transmissive liquid crystal panel, and the light valve is disposed between the projection lens and the light guide module.

17. The projection device according to claim 9, further comprising:
a curved surface reflector, disposed on the transmission path of the illumination light beam and configured to transmit the illumination light beam from the light guide module to the light valve.

18. The projection device according to claim 17, wherein the light valve is a digital micro-mirror device, and the curved surface reflector is disposed between the projection lens and the light valve.
